(19) United States
(12) Patent Application Publication
(10) Pub. No.: US 2022/0218440 A1
(43) Pub. Date: Jul. 14, 2022

(54) SET OF CORRECTION DEVICES FOR CARRYING OUT AN ORTHODONTIC INTERVENTION

(71) Applicant: K LINE EUROPE GmbH, Düsseldorf (DE)

(72) Inventor: Sherif Kandil, Düsseldorf (DE)

(73) Assignee: K LINE EUROPE GmbH, Düsseldorf (DE)

(21) Appl. No.: 17/613,925

(22) PCT Filed: May 12, 2020
(86) PCT No.: PCT/EP2020/063167

§ 371 Date: Nov. 23, 2021

(30) Foreign Application Priority Data
May 30, 2019 (DE) 10 2019 114 593.7

(51) Int. Cl. A61C 7/08

(52) U.S. Cl. CPC A61C 7/08; A61C 2201/007

(57) ABSTRACT

The present disclosure relates to a method for carrying out an orthodontic intervention, using a set of orthodontic correction devices, with the aim of transferring via the correction devices at least part of the teeth from an actual position into a corrected target position, and employing several steps (S1, S2, S3, S3′, S4, S5), each correction device being associated with at least one step. In two subsequent steps (S3, S3′) two correction devices (1; 2), which have a substantially identical shape, are used.

The invention relates to a method for carrying out an orthodontic intervention using a set of orthodontic correction devices. The invention further relates to a set of orthodontic correction devices.

The invention is directed in particular to what is known as a clear aligner. Such an aligner comprises transparent dental splints which are made of polymer and are intended to bring at least part of a set of teeth from an actual position to a corrected target position in a number of steps. The actual position is the initial incorrect position of the part of the set of teeth. The target position is the desired position. The part of the set of teeth can comprise one or more teeth of the set of teeth or be the entire set of teeth.

To make the orthodontic correction devices, a model of the actual state of the set of teeth is firstly made and this forms the basis of further planning. The model can be a conventional plaster model or a digital 3D model. To produce a digital 3D model, the teeth of the patient or a previously produced conventional plaster model can be scanned. Suitable 3D scanners and computer programs for processing the data obtained by means of the 3D scanners are known from the prior art. Furthermore, the objective of the treatment, i.e. a (corrected) target state to be achieved, has to be defined. The target state is likewise recorded in a 3D model. If dental splints, viz. a clear aligner, are used for regulating the teeth, intermediate steps between the initial actual state and the corrected target state are calculated and dental splints matched to one another are produced on the basis of these intermediate steps. These dental splints are each worn for a particular time and move the set of teeth stepwise into the corrected target position. A new dental splint is used for each intermediate step until the corrected target position is attained after the last splint. A procedure of this type is known.

Another field of application of the invention are fixed dental braces. These comprise brackets which are affixed to the teeth and into which a wire is fastened. The wire applies tensile and/or compressive forces to the teeth. When mention is made of correction devices in the context of the invention, this refers in the case of the abovementioned dental braces to the wire, which can also be made up of a number of parts.

The orthodontic intervention is thus carried out in a plurality of steps. Each correction device is assigned to at least one step.

The above-described orthodontic intervention has been proven in principle. However, it has in some cases been found that it does not lead to the desired successful treatment.

Studies have shown that stress relaxation or fatigue phenomena can occur in the correction device during the treatment. It has also been found that the orthodontic intervention causes different biological reactions in different patients. This can have an adverse effect on the quality of the treatment.

In the light of this background, it is the object of the invention to improve the known orthodontic interventions.

This object is achieved by a method having the features of claim 1.

The invention is based on the recognition that when changing the correction device, an at least partial repetition of the last step is advantageous for the further course of the orthodontic intervention. Tests have shown that when, owing to the reasons indicated above, part of the set of teeth does not assume the desired shape in one step, the following steps are likewise no longer carried out so precisely. Here, the invention provides a remedy by a step being at least sometimes carried out twice using successive correction devices. For this purpose, two correction devices which have essentially the same shape are used in two successive steps at least once during the orthodontic intervention.

In conventional methods, each correction device is worn for a particular period of time of, for example, two weeks. The period of time depends on various factors such as the time for which the correction device is worn during a day and the planned movement of the part of the set of teeth. In the prior art, there is thus the sequence S1, S2, S3, S4, S5, S6 etc., where S1 is the first step, S2 is the second step, etc. Each step is prescribed by a shape of a correction device which defines a target position. In contrast, at least one step is repeated according to the invention. In one working example, the sequence is S1, S2, S3, S3′, S4, S5, S5′, S6, etc. The third and the fifth step are thus repeated. Two correction devices which have essentially the same shape are used for this purpose. This has the advantage that in the case of the desired target position of the part of the set of teeth not having been attained in step S3, the desired target position is attained in the repetition of step S3 by the step 3′. The same applies to step S5. The repetition of a step, in the present case the steps S3 and S5, is carried out according to the invention using a new correction device in each case.

For the purposes of the invention, it is possible to use conventional correction devices which are composed of polymer and in the case of which one correction device is assigned to each step. In a development of the invention, it is proposed that the correction device comprises a dynamic material. This can be, for example, a shape memory polymer (SMP) or a shape memory alloy (SMA). Such dynamic materials are also known as 4D materials. The correction device can consist entirely of the dynamic material or have the dynamic material in only one subsection. Possible polymers are, for example, thermoplastic elastomers based on urethane (TPU) or glycol-modified polyethylene terephthalate (PETG). They can be admixed with fillers.

The dynamic material is able to assume stable temporary shapes. For this purpose, the correction device is firstly brought to a final shape during the production of the correction device. The correction device is subsequently brought at least to one temporary shape. A plurality of temporary shapes are also possible. This production procedure is known. In order to bring the correction device from the temporary shape to the final shape, the material is subjected to a stimulus. This can be, for example, water and/or heat. DE 10 2015 108 848 describes a dynamic material which is activated using water. If a plurality of temporary shapes are provided, the activation can also be carried out a number of times, as is known, for example, from WO 2016/131827 A1.

The dynamic material thus makes it possible to provide a correction device, for example a correction splint, having a plurality of steps. Each step is prescribed by a target position of the correction device which corresponds to a desired position of teeth.

An advantageous embodiment of the invention is characterized in that at least a first orthodontic correction device and a second orthodontic correction device which each comprise a dynamic material are provided, with the first correction device and the second correction device each being able to assume a final shape and at least one first temporary shape and with the first correction device and the second correction device when in their first temporary shape assuming a second temporary shape or their final shape as a result of activation of the dynamic material. The correction device is thus a correction device having at least two shapes. Each shape preferably corresponds to one step. In each step, at least one tooth is brought to a target position. The first temporary shape is the initial configuration of the correction device. After activation by heat and/or water, the correction device assumes a second temporary configuration (and optionally further temporary configurations) and finally the final shape. The first correction device and the second correction device are preferably matched so that the first temporary shape of the second correction device corresponds essentially to the final shape of the first correction device. The above-described embodiment of the invention in itself, i.e. independent of other features, constitutes a separate invention and is considered to be independently capable of protection.

The repetition of a step is particularly advantageous in the above advantageous embodiment. Firstly, it has been found that 4D materials in particular do not always revert to their original initial configuration. In some cases, less than 90% of the initial configuration is attained. However, this also means that the teeth do not assume 100% of their desired shape. As a result of the step using the final shape of the first correction device being repeated by means of the first temporary shape of the subsequent correction device, a far greater accuracy of the overall orthodontic intervention can be achieved.

An advantageous embodiment is characterized in that the first temporary shape exerts a greater force on the part of the set of teeth than the second temporary shape and/or the final shape. Basically, good results are achieved in the range from 0.3 to 0.8 newton/mm² during the movement of teeth. However, a (significantly) higher force can be applied by the first temporary shape because the first temporary shape corresponds to the final shape of the preceding correction device, as is proposed as advantageous. The tooth (or part of a set of teeth) is thus moved only little. This can be carried out using a greater force in order to increase the accuracy. In this context, it can also be advantageous for the first temporary shape of the second correction device to apply a greater force to the part of the set of teeth than the final shape of the first correction device. It goes without saying that the comparison is based on the same set of teeth in the same state at the same point in time.

The production of the final shape of the first correction device is preferably carried out using the same three-dimensional model as is used for producing the first temporary shape of the second correction device. This ensures a good correspondence of the final shape of the first correction device and the first temporary shape of the second correction device.

As an alternative, the production of the first temporary shape of the second correction device is carried out using a three-dimensional model having a shape which corresponds to an earlier step of the orthodontic intervention as the three-dimensional model of the final shape of the first correction device. This variant will be used particularly when the correction devices can be activated a number of times, for example five times or ten times. It is then to be expected that the final shape of a correction device does not correspond completely to the initial state. This is compensated for by a three-dimensional model which corresponds to an earlier step or substep. The term substep refers to an intermediate step between two steps.

In an advantageous working example, the first temporary shape of the second correction device has different wall thicknesses in particular sections compared to the final shape of the first correction device. In this way, a greater force can be exerted on particular regions of the part of the set of teeth to be corrected.

The transformation from the final shape, which corresponds to the permanent shape of a correction device, to a temporary shape should be carried out as gently as possible. In the light of this background, it is proposed that, in order to produce the first and/or second temporary shape of the first and/or second correction device, the correction devices be heated to a temperature which is below the material-specific glass transition temperature (Tg). It has been found that in this way the polymer chain structure can be kept intact to a very great extent. The duration of heating is preferably not more than 30 seconds, in particular not more than 10 seconds. This prevents destruction of the polymer chains.

The first and/or second correction device is preferably heated for at least one minute, in particular for at least 10 minutes, to a temperature below the material-specific critical temperature (Tcrit). In this way, unwanted creep of the material can be prevented and alignment of the polymer chains can be achieved. This leads, inter alia, to reduced stress relaxation. Heating can be carried out in a water bath.

The object mentioned at the outset is also achieved by a set of orthodontic correction devices having the features of claim 10. At least part of a set of teeth is intended to be brought to a corrected target position in a number of steps by means of the correction devices, with each correction device being assigned to at least one step. According to the invention, at least a first correction device and a second correction device are matched so that the shape of the second correction device in a subsequent step corresponds essentially to the shape of the first correction device of the preceding step. At least two correction devices are preferably provided for at least one step. The set of correction devices preferably contains at least three correction devices, for example at least five correction devices. It needs to be taken into account here that each correction device can carry out a plurality of steps of the orthodontic intervention.

Further advantageous embodiments may be derived from the dependent claims.

The invention will be illustrated in more detail below with the aid of the accompanying drawing.

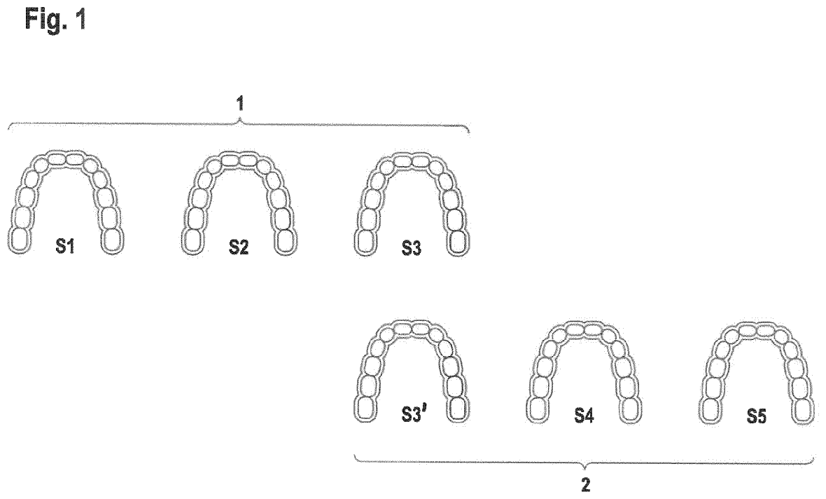

The drawing shows, in FIG. 1, the sequence of a method according to the invention in a schematic depiction.

The reference symbols S1, S2, S3, S3′, S4 and S5 denote individual steps in which part of the set of teeth or the entire set of teeth is moved to a target position. Thus, part of the set of teeth or the entire set of teeth is to be moved in six steps from an (existing) actual position to a corrected target position. According to the invention, at least one step, here: step S3, is repeated, in the present case by means of the step S3′.

The six steps are made available by a first correction device 1 and a second correction device 2. The correction devices are each a clear aligner. However, the invention can also be realized using fixed dental braces. The wire connecting the brackets is then the correction device.

The first correction device 1 has a final shape S3 and two temporary shapes S1 and S2. The second correction device 2 has a final shape S5 and two temporary shapes S3′ and S4. According to the invention, two correction devices 1, 2 are used for at least one step, here: step S3. The two correction devices 1, 2 are matched so that the first temporary shape S3′ of the second correction device 2 corresponds essentially to the final shape S3 of the first correction device. The expression “essentially” is intended to cover manufacturing tolerances. Moreover, the term shape relates to the position of a tooth or teeth covered in each case by the correction device.

FIG. 1 shows only two correction devices. More correction devices can also be provided in the context of the invention. Basically, it is considered to be advantageous for each first temporary shape S3′ of a correction device 2 to correspond essentially to the final shape S3 of a preceding correction device 1.

The working example shown is purely illustrative. It is possible for more or fewer temporary shapes of each correction device to be provided. In addition, more, for example three, four, five or more, correction devices can be provided. The invention has been described with reference to a dental splint (clear aligner). A wire of a fixed dental brace is also possible as correction device. Moreover, the shapes of the individual steps S1 to S5 have been depicted as being the same in the interest of simplicity. It goes without saying that in reality the tooth positions each move slightly until the corrected target position of the set of teeth has been attained in the last step, here: S5.

1. A method for carrying out an orthodontic intervention using a set of orthodontic correction devices comprising:
wherein at least part of a set of teeth of a user is brought from an actual position to a corrected target position in a plurality of steps (S1, S2, S3, S3′, S4, S5) by means of the orthodontic correction devices and;
wherein each orthodontic correction device is assigned to at least one step,
and wherein
two orthodontic correction devices which have essentially the same shape are used at least once in two successive steps.

2. The method as claimed in claim 1,
wherein at least a first orthodontic correction device and a second orthodontic correction device each comprising a dynamic material are provided,
wherein the first orthodontic correction device and the second orthodontic correction device can each assume a final shape (S3; S5) and at least one first temporary shape (S1; S3),
wherein the first orthodontic correction device and the second orthodontic correction device when in their first temporary shape (S1; S3′) assume a second temporary shape (S2; S4) or their final shape (S3; S5) as a result of activation of the dynamic material, and
wherein the first orthodontic correction device and the second orthodontic correction device are matched so that the first temporary shape of the second orthodontic correction device corresponds essentially to the final shape (S3′) of the first orthodontic correction device.

3. The method as claimed in claim 2, wherein the first temporary shape (S1; S3′) of one of said first and second orthodontic correction devices exerts a greater force on the part of the set of teeth than the second temporary shape (S2; S4) and/or the final shape (S3; S5) of said one of said first and second orthodontic correction devices.

4. The method as claimed in claim 2, wherein the first temporary shape (S1; S3′) of the second orthodontic correction device exerts a greater force on the part of the set of teeth than the final shape (S3) of the first orthodontic correction device.

5. The method as claimed in claim 2, wherein the production of the final shape (S3) of the first orthodontic correction device is carried out using the same three-dimensional model as is used for producing the first temporary shape (S3′) of the second orthodontic correction device.

6. The method as claimed in claim 2, wherein the production of the first temporary shape (S3′) of the second orthodontic correction device is carried out using a three-dimensional model having a shape which corresponds to an earlier step of the orthodontic intervention as the three-dimensional model of the final shape (S3) of the first orthodontic correction device.

7. The method as claimed in claim 2, wherein the first temporary shape (S3′) of the second orthodontic correction device has different wall thicknesses in particular sections than the final shape (S3) of the first orthodontic correction device.

8. The method as claimed in claim 2, wherein in order to produce the first and/or second temporary shape (S1, S2; S3′, S4) of the first orthodontic correction device and/or the second orthodontic correction device, said first and second orthodontic correction devices are heated to a temperature below the material-specific glass transition temperature (Tg), with the duration of heating being not more than 30 seconds, preferably not more than 10 seconds.

9. The method as claimed in claim 2, wherein the first orthodontic correction device and/or said second orthodontic correction device is heated to a temperature below the material-specific critical temperature (Tcrit) for at least one minute, preferably for at least 10 minutes.

10. A set of orthodontic correction devices comprising:
wherein at least part of a set of teeth of a user is to be brought to a corrected position in a plurality of steps (S1, S2, S3, S3′, S4, S5) by means of the orthodontic correction devices,
wherein each orthodontic correction device is assigned to at least one step,
wherein
in that at least a first orthodontic correction device and a second orthodontic correction device are matched so that the shape of the second orthodontic correction device in a subsequent step (S3′) corresponds essentially to the shape of the first orthodontic correction device of the preceding step (S3).

11. The set of orthodontic correction devices as claimed in claim 10, wherein:
said first orthodontic correction device and said second orthodontic correction device each comprises a dynamic material,
wherein the first orthodontic correction device and the second orthodontic correction device can each assume a final shape (S3; S5) and at least one first temporary shape (S1; S3′),
wherein the first orthodontic correction device and the second orthodontic correction device when in their first temporary shape (S1; S3′) assume a second temporary shape (S2; S4) or their final shape (S3; S5) as a result of activation of the dynamic material,
wherein
in that the first orthodontic correction device and the second orthodontic correction device are matched so that the first temporary shape (S3′) of the second orthodontic correction device corresponds essentially to the final shape (S3) of the first orthodontic correction device.

12. The set as claimed in claim 11, wherein the first temporary shape (S1; S3′) of one of said first and second orthodontic correction devices is configured so that it exerts a greater force on the part of the set of teeth than the respective second temporary shape (S2; S4) and/or the final shape (S3; S5) of said one of said first and second orthodontic correction devices.

13. The set as claimed in claim 11, wherein the first temporary shape (S1; S3′) of the second orthodontic correction device is configured so that it exerts a greater force on the part of the set of teeth than the final shape (S3) of the first orthodontic correction device.
